(19) United States
(12) Patent Application Publication
(10) Pub. No.: US 2010/0023970 A1
(43) Pub. Date: Jan. 28, 2010

(54) Transmitting apparatus, receiving apparatus, transmission/reception method, transmission/reception system, and recording medium thereof

(75) Inventor: Kenichi Inoue, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/460,133

(22) Filed: Jul. 14, 2009

(30) Foreign Application Priority Data
Jul. 17, 2008 (JP) P2008-186215

(51) Int. Cl. G06F 13/00

(52) U.S. Cl. 725/50; 725/55

(57) ABSTRACT

The present invention provides a transmitting apparatus including an acquisition unit that acquires electronic program guide information contained in broadcast waves; a recording unit that records the electronic program guide information acquired by the acquisition unit in a storage medium; a determination unit that determines whether the electronic program guide information has changed, by comparing the electronic program guide information recorded in the storage medium and the electronic program guide information newly acquired by the acquisition unit; and a transmitting unit that transmits, when the determination unit determines that the electronic program guide information has changed, the newly acquired electronic program guide information to one or more than one receiving apparatuses connected via a network.

### CROSS-REFERENCE TO RELATED APPLICATION

The present application claims priority from Japanese Patent Application JP 2008-186215 filed in the Japanese Patent Office on Jul. 17, 2008, the entire content of which is incorporated herein by reference.

### BACKGROUND OF THE INVENTION

1. Field of the Invention

The present invention relates to a transmitting apparatus, a receiving apparatus, a transmission method, a transmission system, and a recording medium thereof, and in particular, relates to a transmitting apparatus and a receiving apparatus that transmits and receives electronic program guide information, a transmission method, a transmission system, and a recording medium thereof.

2. Description of the Related Art

In recent years, a system called an EPG (Electronic Program Guide) that digitizes and displays a TV program guide on a TV screen has been practically used. The EPG sends out as data containing electronic program guide information by using a gap in radio waves and the data is received by a dedicated terminal such as a recorder. EPG information contains not only TV program guide information, but also information about programs such as the program start date/time and end date/time, program names, program contents, genre names, and performers.

Among recording and reproducing devices that record and reproduce data containing video and/or audio such as personal computers with a HDD/DVD recorder and a TV tuner, those having a function to use EPG information can receive EPG information delivered by the terrestrial data broadcasting or the Internet and display the EPG on a display device such as a CRT connected to the recording and reproducing devices.

When a user owns a plurality of recording and reproducing devices, EPG information is received by each of the plurality of recording and reproducing devices. In this case, each of the plurality of recording and reproducing devices can independently acquire the latest EPG information from TV broadcast waves. However, timing to acquire EPG information is different from recording device to recording device. Moreover, it takes several dozen minutes to about an hour to acquire EPG information. Therefore, there is an issue that the latest EPG information is different in each recording and reproducing device.

Thus, a technology to make EPG information held by a plurality of recording and reproducing devices up-to-date by electronic program guide information of other devices being referenced by one recorder of the plurality of recording and reproducing devices sharing the EPG information is disclosed (for example, Japanese Patent Application Laid-Open No. 2005-175788 and Japanese Patent Application Laid-Open No. 2007-208927).

[Patent Document 1] Japanese Patent Application Publication No. 2005-175788

[Patent Document 2] Japanese Patent Application Publication No. 2007-208927

### SUMMARY OF THE INVENTION

However, in order to acquire EPG information, extra electric power that is not used at present (so-called standby electricity) is used. Therefore, when each recording and reproducing device receives EPG information repeatedly at fixed intervals in a day, there was an issue that the standby electricity to receive EPG information increases in proportion to the number of owned recording and reproducing devices.

Thus, the present invention has been made in view of the above issues and there is a need for a novel and improved transmitting apparatus and receiving apparatus, a transmission method, a transmission system, and a program thereof, capable of sharing electronic program guide information among a plurality of apparatuses by reducing standby electricity.

According to an embodiment of the present invention, there is provided a transmitting apparatus, including: an acquisition unit that acquires electronic program guide information contained in broadcast waves; a recording unit that records the electronic program guide information acquired by the acquisition unit in a storage medium; a determination unit that determines whether the electronic program guide information has changed, by comparing the electronic program guide information recorded in the storage medium and the electronic program guide information newly acquired by the acquisition unit; and a transmitting unit that transmits, when the determination unit determines that the electronic program guide information has changed, the newly acquired electronic program guide information to one or more than one receiving apparatuses connected via a network.

With the above configuration, when an electronic program guide information has changed after comparing the electronic program guide information acquired from broadcast waves and the electronic program guide information recorded in a storage medium, the newly acquired electronic program guide information is transmitted to other apparatuses connected via a network. Moreover, an acquisition time of electronic program guide information which is when electronic program guide information is acquired is transmitted together with the electronic program guide information so that electronic program guide information contained in broadcast waves is acquired at the time indicated by the transmitted acquisition time of electronic program guide information.

Accordingly, electronic program guide information can be shared by a plurality of apparatuses by reducing standby electricity. When a plurality of recorders is connected via a network, one of the plurality of recorders acquires EPG information from broadcast waves and transmits the EPG information to the other recorders. Accordingly, power consumption can be reduced by reducing the number of times of turning power on to acquire EPG information from broadcast waves.

The acquisition unit may acquire the electronic program guide information in a predetermined period of time, the recording unit may record the electronic program guide information in the predetermined period of time acquired by the acquisition unit in the storage medium, the determination unit may determine whether the electronic program guide information in the predetermined period of time has changed, by comparing the electronic program guide information recorded in the storage medium in the predetermined period of time and the electronic program guide information newly acquired by the acquisition unit, and the transmitting unit may transmit, when the determination unit determines that the electronic program guide information in the predetermined period of time has changed, the newly acquired electronic program guide information to one or more than one receiving apparatuses immediately after the electronic program guide information is acquired by the acquisition unit.

The electronic program guide information contains program information indicating names and contents of programs and time information indicating a time when the electronic program guide information was acquired, and when the determination unit determines that the electronic program guide information has not changed, the transmitting unit may transmit only the time information contained in the electronic program guide information.

The transmitting apparatus includes a decision unit that decides an acquisition time of electronic program guide information which is when electronic program guide information is acquired subsequently, in accordance with the time when the electronic program guide information contained in the electronic program guide information was acquired, and the transmitting unit may transmit the acquisition time of electronic program guide information indicating when the electronic program guide information is acquired to the receiving apparatus together with the electronic program guide information, the acquisition time being decided by the decision unit.

According to another embodiment of the present invention, there is provided a receiving apparatus, including: a receiving unit that receives an acquisition time of electronic program guide information indicating the time when the electronic program guide information is acquired and electronic program guide information, transmitted from a transmitting apparatus connected to a network; a recording unit that records the electronic program guide information received by the receiving unit in a storage medium; an acquisition unit that acquires the electronic program guide information contained in broadcast waves at the time indicated by the acquisition time of electronic program guide information received by the receiving unit; and a determination unit that determines whether the electronic program guide information has changed, by comparing the electronic program guide information recorded in the storage medium and the electronic program guide information acquired by the acquisition unit, wherein when the determination unit determines that the electronic program guide information has changed, the recording unit records the acquired electronic program guide information in the storage medium.

The electronic program guide information contains program information indicating names and contents of programs and time information indicating a time when the electronic program guide information was acquired, and when only the time information contained in the electronic program guide information is transmitted by the transmitting apparatus, the receiving unit may update only the time information of the electronic program guide information recorded in the storage medium.

According to another embodiment of the present invention, there is provided a transmission method, including the steps of: acquiring electronic program guide information contained in broadcast waves; recording the acquired electronic program guide information in a storage medium; determining whether the electronic program guide information has changed, by comparing the electronic program guide information recorded in the storage medium and the electronic program guide information newly acquired by the step of acquiring; and transmitting, when it is determined that the electronic program guide information has changed, the newly acquired electronic program guide information to one or more than one receiving apparatuses connected via a network.

According to another embodiment of the present invention, there is provided a reception method, including the steps of: receiving an acquisition time of electronic program guide information indicating the time when the electronic program guide information is acquired and electronic program guide information, transmitted from a transmitting apparatus connected to a network; recording the received electronic program guide information in a storage medium; acquiring the electronic program guide information contained in broadcast waves at the time indicated by the received acquisition time of electronic program guide information; and determining whether the electronic program guide information has changed, by comparing the electronic program guide information recorded in the storage medium and the electronic program guide information acquired by the step of acquiring.

According to another embodiment of the present invention, there is provided a program recording medium storing a program to cause a computer to function as a transmitting apparatus, including: an acquisition unit that acquires electronic program guide information contained in broadcast waves; a recording unit that records the electronic program guide information acquired by the acquisition unit in a storage medium; a determination unit that determines whether the electronic program guide information has changed, by comparing the electronic program guide information recorded in the storage medium and the electronic program guide information newly acquired by the acquisition unit; and a transmitting unit that transmits, when the determination unit determines that the electronic program guide information has changed, the newly acquired electronic program guide information to one or more than one receiving apparatuses connected via a network.

According to another embodiment of the present invention, there is provided a program recording medium storing a program to cause a computer to function as receiving apparatus, including: a receiving unit that receives an acquisition time of electronic program guide information indicating the time when the electronic program guide information is acquired and electronic program guide information, transmitted from a transmitting apparatus connected to a network; a recording unit that records the electronic program guide information received by the receiving unit in a storage medium; an acquisition unit that acquires the electronic program guide information contained in broadcast waves at the time indicated by the acquisition time of electronic program guide information received by the receiving unit; and a determination unit that determines whether the electronic program guide information has changed, by comparing the electronic program guide information recorded in the storage medium and the electronic program guide information acquired by the acquisition unit, wherein when the determination unit determines that the electronic program guide information has changed, the recording unit records the acquired electronic program guide information in the storage medium.

According to another embodiment of the present invention, there is provided a transmission/reception system including: a transmitting apparatus including; an acquisition unit that acquires electronic program guide information contained in broadcast waves, a recording unit that records the electronic program guide information acquired by the acquisition unit in a storage medium, a determination unit that determines whether the electronic program guide information has changed, by comparing the electronic program guide information recorded in the storage medium and the electronic program guide information newly acquired by the acquisition unit, and a transmitting unit that transmits, when the determination unit determines that the electronic program guide information has changed, the newly acquired electronic program guide information to one or more than one receiving apparatuses connected via a network, and a receiving apparatus including; a receiving unit that receives an acquisition time of electronic program guide information indicating the time when the electronic program guide information is acquired and electronic program guide information, transmitted from a transmitting apparatus, a recording unit that records the electronic program guide information received by the receiving unit in a storage medium, an acquisition unit that acquires the electronic program guide information contained in broadcast waves at the time indicated by the acquisition time of electronic program guide information received by the receiving unit, and a determination unit that determines whether the electronic program guide information has changed, by comparing the electronic program guide information recorded in the storage medium and the electronic program guide information acquired by the acquisition unit, wherein the transmitting apparatus and the receiving apparatus are connected via a network

According to the embodiments of the present invention described above, electronic program guide information can be shared among a plurality of apparatuses by reducing standby electricity.

### BRIEF DESCRIPTION OF THE DRAWINGS

FIG. 1 is an explanatory view providing an overview of a transmission/reception system according to an embodiment of the present invention;

FIG. 2 is a block diagram showing an internal structure of a recorder according to the embodiment;

FIG. 3 is an explanatory view illustrating an acquisition of EPG information from broadcast waves by the recorder according to the embodiment;

FIG. 4 is a block diagram showing a function configuration of a transmitting apparatus and a receiving apparatus according to the embodiment;

FIG. 5 is an explanatory view illustrating the acquisition of electronic program guide information and back power supply ON of recorders according to the embodiment;

FIG. 6 is an explanatory view illustrating the acquisition of electronic program guide information and back power supply ON of the recorders according to the embodiment;

FIG. 7 is an explanatory view illustrating the acquisition of electronic program guide information and back power supply ON of the recorders according to the embodiment;

FIG. 8 is a flow chart illustrating a transmission method of the EPG information according to the embodiment;

FIG. 9 is a flow chart illustrating a transmission of difference of the EPG information in the recorder according to the embodiment; and

FIG. 10 is an explanatory view illustrating an acquisition method of the EPG information by a TV receiver in the related art.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Also, the “Best Mode for Carrying Out the Invention” will be described according to the sequence shown below:

[1] Object of the present embodiment

[2] Overview of transmission/reception system

[3] Internal structure of transmitting apparatus/receiving apparatus

[4] Function configuration of transmitting apparatus/receiving apparatus

[5] Operation of transmission/reception system

### [1] Object of the Present Embodiment

First, the object of the embodiment of the present invention will be described. In recent years, a system called the EPG (Electronic Program Guide) that digitizes and displays a TV program guide on a TV screen has been practically used. The EPG sends out data containing electronic program guide information by using a gap in radio waves and that data is received by a dedicated terminal such as a recorder. EPG information (also called electronic program guide information) contains not only TV program guide information, but also information about programs such as the program start date/time and end date/time, program names, program contents, genre names, and performers.

Among recording and reproducing devices that record and reproduce data containing video and/or audio such as personal computers with a HDD/DVD recorder and a TV tuner, those having a function to use EPG information can receive EPG information delivered by the terrestrial data broadcasting or the Internet and display the EPG on a display device such as a CRT connected to the recording and reproducing devices.

When a user owns a plurality of recording and reproducing devices, EPG information is received by each of the plurality of recording and reproducing devices. In this case, each of the plurality of recording and reproducing devices can independently acquire the latest EPG information from TV broadcast waves. However, timing to acquire EPG information is different in each recording device. Moreover, it takes several dozen minutes to about an hour to acquire EPG information. Thus, a technology to make EPG information held by a plurality of recording and reproducing devices up-to-date by electronic program guide information of other devices being referenced by one recorder of the plurality of recording and reproducing devices sharing the EPG information is disclosed.

However, in order to acquire EPG information, extra electric power that is not used at present (so-called standby electricity) is used. Therefore, when each recording and reproducing device receives EPG information repeatedly at fixed intervals in a day, there was an issue that the standby electricity to receive EPG information increases in proportion to the number of owned recording and reproducing devices. Thus, with the above circumstances being focused on, a transmission/reception system 1 according to an embodiment of the present invention has been created. According to the transmission/reception system 1 in the present embodiment, a plurality of apparatuses can share electronic program guide information by reducing standby electricity.

### [2] Overview of Transmission/Reception System

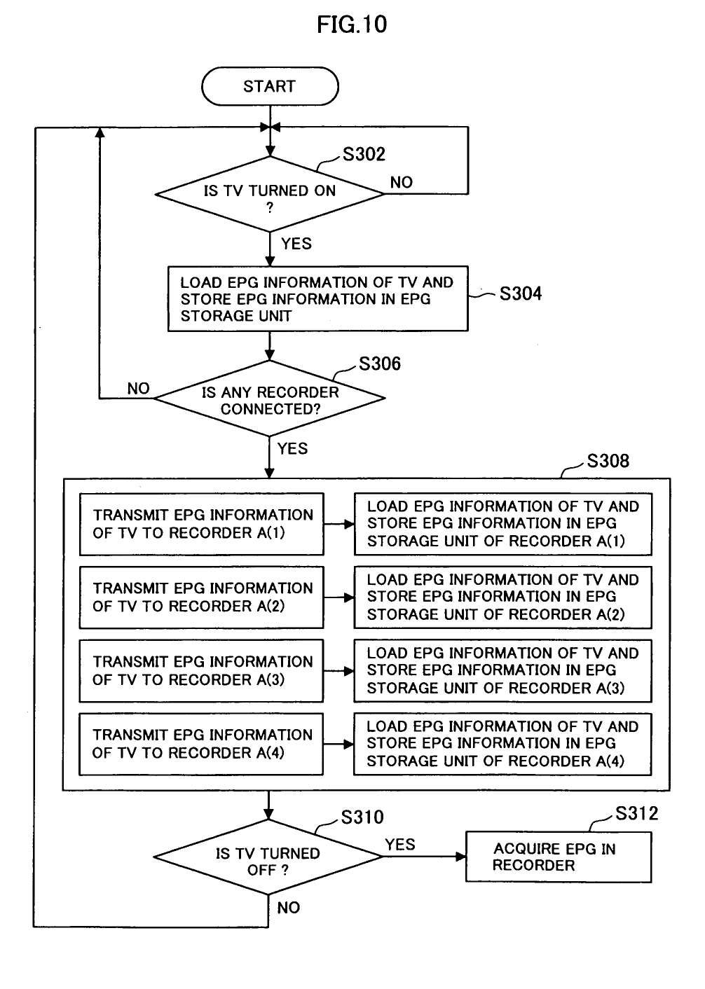

First, the acquisition method of EPG information by a TV receiver in the related art will be described with reference to FIG. 10. In FIG. 10, the acquisition method of EPG information when a plurality of recorders is directly connected to the TV receiver is illustrated. In the past, it took a long time to acquire EPG information of any channel other than that being viewed because the reproductive cycle of EPG was long. Therefore, it took time before EPG of any channel other than that being viewed was displayed after the TV receiver had been turned on.

Moreover, even if the EPG information of all channels was acquired in such a manner by taking a long time, it was necessary to provide a large-capacity memory (a volatile memory and non-volatile memory) to accumulate or retain acquired EPG information. Since EPG information disappeared when power was turned off, it was necessary to acquire EPG information again each time power was turned on.

Therefore, storing once acquired EPG information in a non-volatile memory can be considered. When power is turned on after being temporarily turned off, EPG information whose acquisition needs a long time is acquired from EPG information accumulated in the non-volatile memory. Accordingly, EPG information can be displayed swiftly.

As shown in FIG. 10, when a TV receiver is turned on (S302), EPG information of the TV receiver is loaded and saved in an EPG storage unit (S304). Then, when recorders are connected (S306), the EPG information is transmitted to each recorder to save the EPG information in the EPG storage unit of each recorder (S308). Then, when the TV receiver is turned off (S310), the EPG information stored in the recorder is acquired (S312).

However, even if a method like the above is used, EPG information that has not been acquired before power being turned off is not stored in the non-volatile memory and thus, it is necessary to acquire such EPG information from broadcast waves after power being turned on. Next, after the TV receiver is turned off, shared EPG information is transferred from the recorder. When a long time has passed after the TV receiver being turned off until the TV receiver is turned on again, EPG information stored in the non-volatile memory has become old data.

Therefore, EPG information of the program to be displayed may not be contained in EPG information stored in the non-volatile memory or when a broadcasting schedule is changed, EPG information after the change may not be contained. In such a case, it is necessary, after all, as before, to acquire EPG information from broadcast waves after power being turned on in order to acquire the latest EPG information and an issue that it takes time to display the latest EPG information arises.

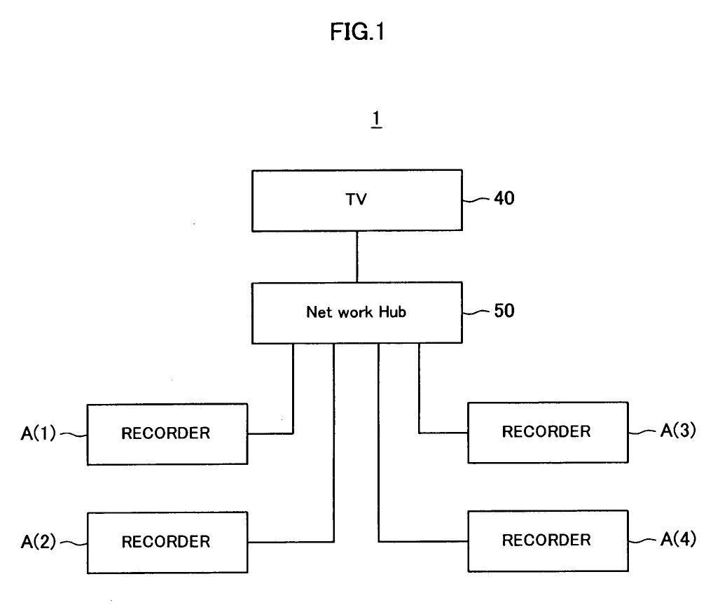

Thus, the present embodiment proposes, as shown in FIG. 1, the transmission/reception system 1 in which a plurality of recorders (A1 to A4) is connected to a TV receiver (TV) 40 via a network hub (Net Work Hub) 50. According to the transmission/reception system 1, it becomes possible to share the latest EPG information acquired by each recorder via a network. Further, standby electricity can be reduced by reducing the number of times of turning on each recorder. Details of the transmission/reception system 1 will be described below.

### [3] Internal Structure of Transmitting Apparatus/Receiving Apparatus

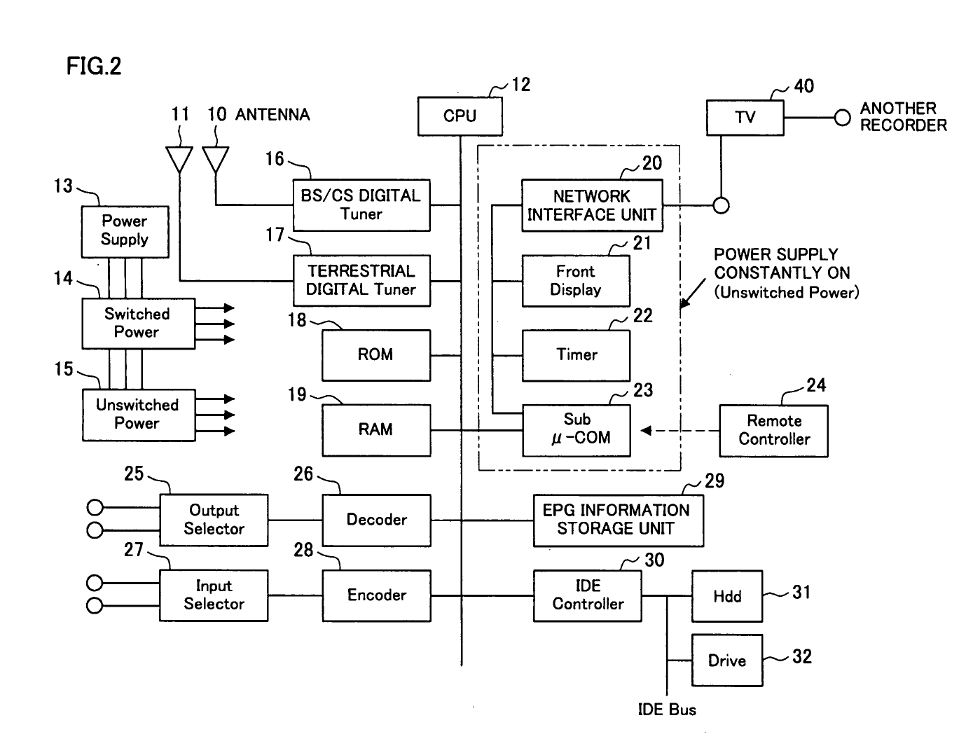

First, the internal structure of a transmitting apparatus 100 and a receiving apparatus 200 according to the present embodiment will be described below. FIG. 2 is a block diagram showing the internal structure of a recorder (A(1) to A(4)) (hereinafter, referred to as a recorder A), which is an example of the transmitting apparatus 100 and the receiving apparatus 200. As shown in FIG. 2, the recorder A mainly includes antennas 10 and 11, a CPU 12, a BS/CS digital tuner 16, a terrestrial digital tuner 17, a ROM 18, a RAM 19, a network interface unit 20, a front display (Front Display) 21, a timer (Timer) 22, a Subμ-COM 23, an output selector (Output Selector) 25, a decoder (Decoder) 26, an input selector (Input Selector) 27, and an encoder (Encoder) 28.

The antenna 10 receives BS/CS digital broadcast waves to provide a signal obtained after frequency conversion of broadcast waves being performed to the BS/CS digital tuner 16. The antenna 11 receives terrestrial digital broadcast waves to provide a signal obtained after frequency conversion of broadcast waves being performed to the terrestrial digital tuner 17. The BS/CS digital tuner 16 and the terrestrial digital tuner 17 extract a signal of a specific frequency from a received high-frequency digital modulating signal.

In memories such as the ROM 18 and the RAM 19, programs executed by the CPU 12, program information, user input information, program setting information and the like are stored. The CPU 12 controls a processing operation of the recorder A according to programs stored in the ROM 18.

In a recent network environment, EPG information can be acquired faster than acquiring EPG information from broadcast waves. Thus, in the present embodiment, a portion (the network interface unit 20, the front display 21, the timer 22, and the Subμ-COM 23) of the recorder A is made to be constantly ON with low power.

The Subμ-COM 23 has a function to program timing of a back power supply being turned on in each recorder so as to acquire EPG information. Here, the back power supply is a power supply turned on by a recorder to acquire EPG information when the recorder is not turned on by user input. If it is assumed that EPG information is acquired from broadcast waves every two hours, after one recorder acquires EPG information, other recorders will normally acquire the EPG information one after another every two hours.

When, for example, four recorders are connected to a network, it will only be necessary for the recorder that first acquires EPG information to be turned on after eight hours. Then, when the recorder has not acquired EPG information, the recorder can share the EPG information in a short time via a network. Thus, in the present embodiment, when a plurality of recorders is used, standby electricity of back power supply ON can significantly be reduced.

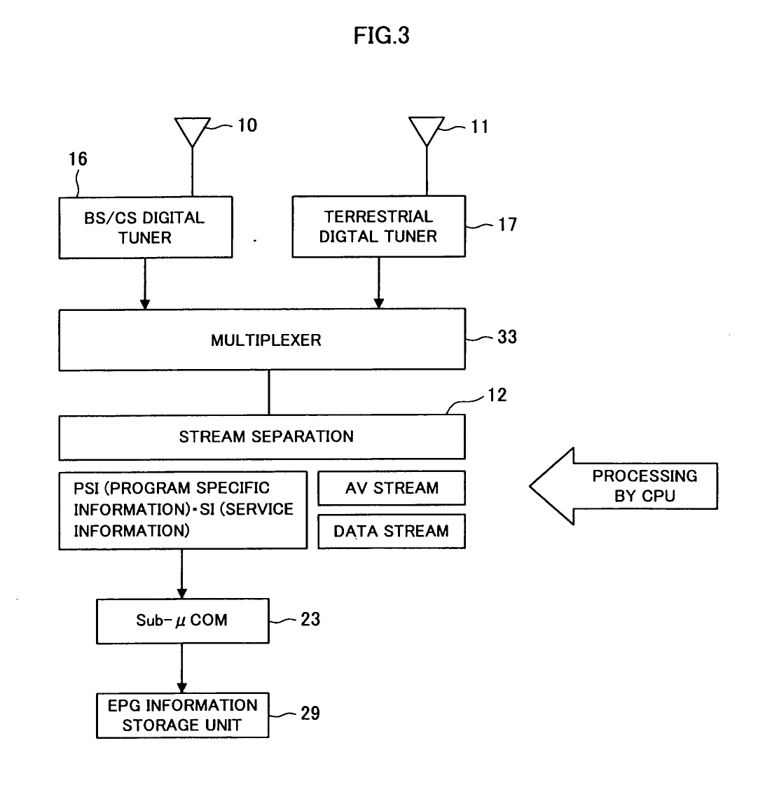

Next, the acquisition of EPG information by the recorder A from broadcast waves will be described with reference to FIG. 3. BS/CS digital broadcast waves received by the antenna 10 of the BS/CS digital tuner are provided to the BS/CS digital tuner 16 after frequency conversion. Also, terrestrial digital broadcast waves received by the antenna 11 of the terrestrial digital tuner are provided to the terrestrial digital tuner 17 after frequency conversion.

Specific frequencies are extracted by the BS/CS digital tuner 16 and the terrestrial digital tuner 17 and provided to a multiplexer 33. The multiplexer 33 synthesizes two signals provided by the BS/CS digital tuner 16 and the terrestrial digital tuner 17 into one signal, which is provided to the CPU 12. The CPU 12 separates the provided signal (stream) into PSI/SI containing program information and the like, an AV stream containing video/audio, and a data stream such as letters. Then, the Subμ-COM 23 stores the PSI/SI in an EPG information storage unit 29. In the foregoing, the acquisition of EPG information by the recorder A from broadcast waves has been described.

### [4] Function Configuration of Transmitting Apparatus/Receiving Apparatus

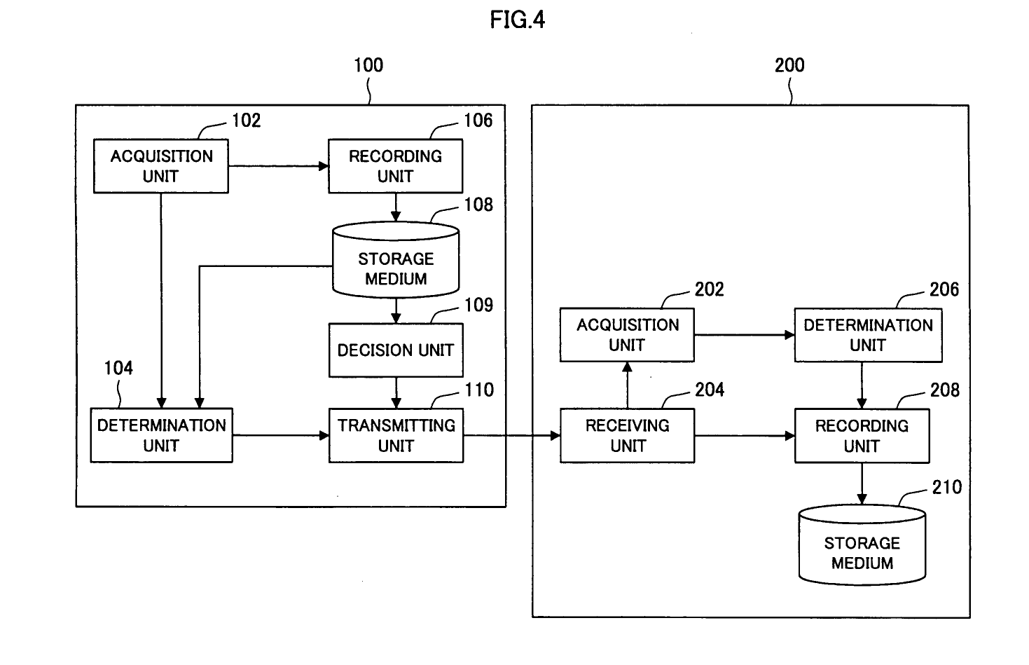

Next, the function configuration of the transmitting apparatus 100 and the receiving apparatus 200 according to the present embodiment will be described with reference to FIG. 4. As described above, the recorder A can be exemplified as the transmitting apparatus 100 or the receiving apparatus 200. The recorder A may be caused to function as the transmitting apparatus 100 or the receiving apparatus 200 or have a function of the transmitting apparatus 100 or the receiving apparatus 200.

As shown in FIG. 4, the transmitting apparatus 100 includes an acquisition unit 102, a determination unit 104, a recording unit 106, a storage medium 108, a transmitting unit 110 and the like. The receiving apparatus 200 includes an acquisition unit 202, a receiving unit 204, a determination unit 206, a recording unit 208, a storage medium 210 and the like.

The acquisition unit 102 has a function to acquire electronic program guide information contained in broadcast waves. The above CPU 12 or Subμ-COM 23 can be exemplified as the acquisition unit 102 and has a function to extract electronic program guide information from specific frequencies received by the above antenna 10 or antenna 11 and extracted by the tuners.

Electronic program guide information has a common portion and a specific information portion. The common portion contains an event information table including the program name, broadcasting date/time, a description of program content and the like, a time offset table including the current date/time, a service description table including the names and information of scheduled programs and the like. The specific information portion contains program setting information set in each recorder.

The recording unit 106 has a function to record electronic program guide information acquired by the acquisition unit 102 in the storage medium 108. The above Subμ-COM 23 can be exemplified as the recording unit 106. The recording unit 106 may store electronic program guide information in the storage medium 108 by separating the electronic program guide information into a common portion acquired from broadcast waves and a specific information portion set by the recorder.

The determination unit 104 has a function to determine whether electronic program guide information has changed, by comparing electronic program guide information recorded in the storage medium 108 and the electronic program guide information acquired by the acquisition unit 102. The above Subμ-COM 23 can be exemplified as the determination unit 104. Then, when the determination unit 104 determines that electronic program guide information has changed, the transmitting unit 110 transmits the newly acquired electronic program guide information to the receiving apparatus 200 connected via a network. In FIG. 4, only the receiving apparatus 200 is connected to the transmitting apparatus 100, but connection is not limited to the above example and a plurality of receiving apparatuses may be connected to the transmitting apparatus 100.

Normally, electronic program guide information is acquired as information for eight days. When, for example, data for eight days does not change abruptly, the determination unit 104 determines that electronic program guide information has not changed and no data is transmitted by the transmitting unit 110. When, on the other hand, data for the ninth day is generated and the determination unit 104 determines that electronic program guide information has changed, the transmitting unit 110 transmits only a difference of data to the receiving apparatus 200. In this case, the transmitting unit 110 may transmit electronic program guide information immediately after being acquired by the acquisition unit 102.

A decision unit 109 has a function to decide an acquisition time of electronic program guide information to acquire the electronic program guide information subsequently, in accordance with the time when electronic program guide information was acquired contained in the electronic program guide information. The above Subμ-COM 23 can be exemplified as the decision unit 109. When, for example, three units of the receiving apparatus 200 are connected to the transmitting apparatus 100 and electronic program guide information is acquired every two hours, eight hours after electronic program guide information is first acquired is set as the acquisition time of electronic program guide information.

The acquisition time of electronic program guide information can be set for each unit of the receiving apparatus 200. When, for example, three units of the receiving apparatus 200 are connected to the transmitting apparatus 100 and electronic program guide information is acquired every two hours, the time obtained by adding two hours to the acquisition time of electronic program guide information of the transmitting apparatus 100, the time obtained by adding four hours, or the time obtained by adding six hours may also be set as the acquisition time of electronic program guide information.

Then, the transmitting unit 110 transmits the acquisition time of electronic program guide information decided by the decision unit 109 indicating the time when electronic program guide information is acquired is transmitted to the receiving apparatus 200 together with the electronic program guide information. In the foregoing, the function configuration of the transmitting apparatus 100 has been described. Next, the function configuration of the receiving apparatus 200 will be described.

As shown in FIG. 4, the receiving apparatus 200 includes the acquisition unit 202, the receiving unit 204, the determination unit 206, the recording unit 208, the storage medium 210 and the like. The receiving unit 204 has a function to receive the acquisition time of electronic program guide information which is when the electronic program guide information is acquired and electronic program guide information, transmitted from a transmitting apparatus connected to a network.

The recording unit 208 has a function to record electronic program guide information received by the receiving unit 204 in a storage medium. The acquisition unit 202 has a function to acquire electronic program guide information contained in broadcast waves at the time indicated by the acquisition time of electronic program guide information received by the receiving unit 204.

The determination unit 206 has a function to determine whether electronic program guide information has changed, by comparing electronic program guide information recorded in a storage medium and the electronic program guide information acquired by the acquisition unit 202. When the determination unit 206 determines that electronic program guide information has changed, the recording unit 208 has a function to record the acquired electronic program guide information in the storage medium. In the foregoing, the function configuration of the receiving apparatus 200 has been described.

The transmitting apparatus 100 and the receiving apparatus 200 are separate apparatuses in the present embodiment, but the present embodiment is not limited to such an example. For example, the transmitting apparatus 100 and the receiving apparatus 200 may be an integral-type apparatus. That is, a plurality of recorders, each of which can be exemplified as the transmitting apparatus 100 and the receiving apparatus 200 and having functions of the transmitting apparatus 100 and the receiving apparatus 200, may be connected via a network.

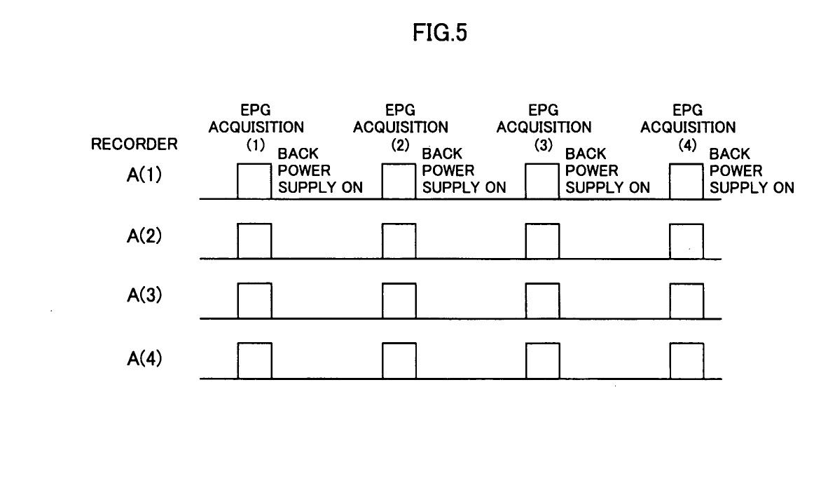

Next, the acquisition of electronic program guide information (EPG information) and back power supply ON (ON) of recorders when four recorders are connected via a network will be described with reference to FIG. 5 to FIG. 7.

FIG. 5 is an explanatory view illustrating the acquisition method in the related art of EPG information from broadcast waves and back power supply ON cycle. As shown in FIG. 5, each of the recorders A(1) to A(4) acquires EPG information from broadcast waves by turning on the back power supply in accordance with the acquisition cycle of EPG information. EPG information is acquired from broadcast waves by turning on the back power supply periodically when other recorders than the recorder in use are on standby. Therefore, standby electricity for four units is consumed in a cycle of EPG information.

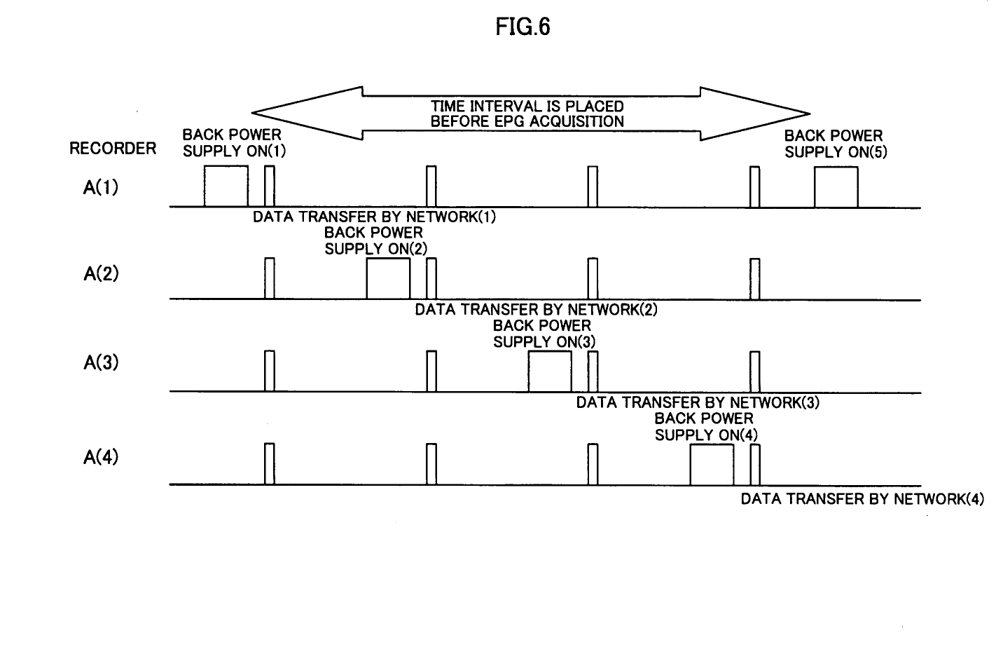

In the present embodiment, power consumption can be reduced by reducing the number of times of turning on wasteful power supplies through transmitting/receiving, via a network, EPG information acquired by one of the recorders A(1) to A(4). For example, as shown in FIG. 6, each of the recorders A(1) to A(4) acquires EPG information from broadcast waves in every few hours. That is, each recorder can make the time interval between the first EPG acquisition and the next EPG acquisition four times as long as the normal time interval so that the number of times of turning on the back power supply can be reduced. When it is necessary, for example, to acquire EPG

information every two hours, it is necessary for each of the recorders A(1) to A(4) to acquire EPG information from broadcast waves eight hours after first acquiring EPG information from broadcast waves.

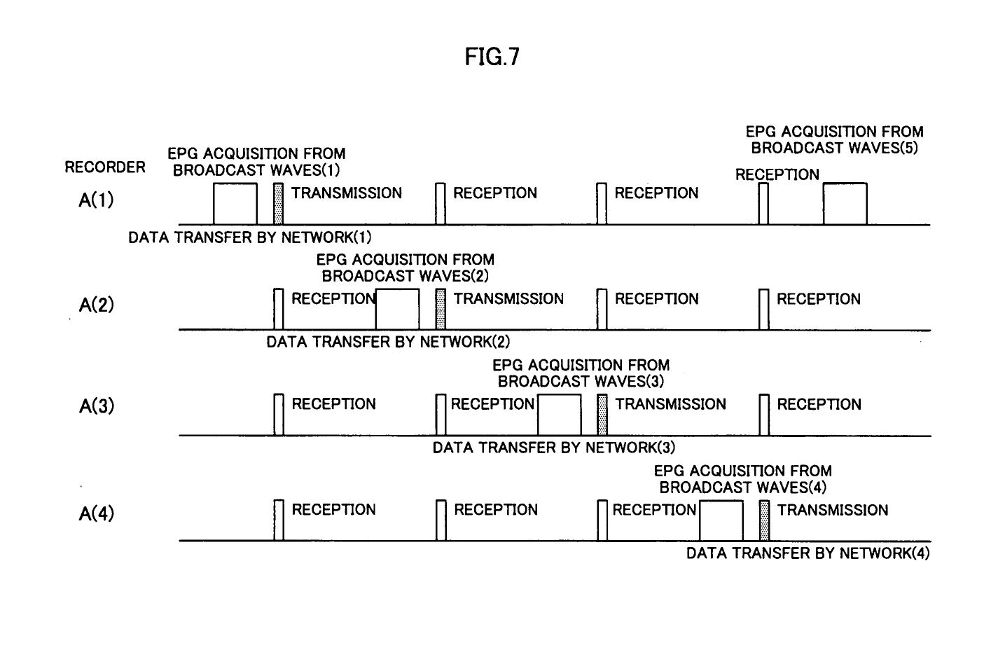

As shown in FIG. 7, In order that the recorders A(1) to A(4) update EPG information every two hours, EPG information acquired by one of the units is transmitted to the other recorders or EPG information is received from the other recorders. For example, when the recorder A(1) acquires EPG information from broadcast waves (1), the recorder A(1) transmits the EPG information to the recorders A(2) to A(4) via a network. Then, the recorders A(2) to A(4) receive the EPG information from the recorder A(1) via the network.

Next, the recorder A(2) acquires EPG information from broadcast waves (2) and transmits the EPG information to the recorders A(1), A(3), and A(4) via the network. Then, the recorders A(1), A(3), and A(4) receive the EPG information from the recorder A(2) via the network. Further, the recorder A(3) acquires EPG information from broadcast waves (3) and transmits the EPG information to the recorders A(1), A(2), and A(4) via the network. Then, the recorders A(1), A(2), and A(4) receive the EPG information from the recorder A(3) via the network.

Further, the recorder A(4) acquires EPG information from broadcast waves (4) and transmits the EPG information to the recorders A(1) to A(3) via the network. Then, the recorders A(1) to A(3) receive the EPG information from the recorder A(4) via the network. With EPG information being acquired sequentially and the acquired EPG information being transmitted to the other recorders in this manner, EPG information can be shared by a plurality of apparatuses by reducing the number of times of turning on the back power supply, and thereby reducing standby electricity.

Each recorder may be set to transmit EPG information to the other recorders only when any change occurs. Assume, for example, that each recorder acquires EPG information for the eight days. In this case, when there is no abrupt change in EPG data for the eight days, the EPG data is not transmitted to the other recorders. When EPG data for the ninth day is generated in the acquired EPG information so that there is a change in the currently held EPG data, a difference of data is transmitted. However, since time information contained in EPG information is updated, the time information is necessarily transmitted.

Each recorder transmits the time when the recorder that receives information acquires EPG information from broadcast waves subsequently, as well as EPG information and time information. Accordingly, the recorder that has received EPG information and the like can acquire EPG information from broadcast waves based on the transmitted time. Therefore, when a plurality of recorders is connected via a network, EPG information can sequentially be acquired at fixed intervals.

Whether to transmit EPG information to other recorders may be determined in accordance with the importance of the EPG information. When, for example, important information is contained in EPG information, the EPG information is immediately transmitted to other recorders via a network due to great urgency. When no important information is contained in EPG information, the EPG information may be transmitted when another recorder is connected to the network or turned on due to lack of urgency.

As described above, EPG information contains not only TV program guide information, but also information such as the program start date/time and end date/time, program name, program contents, genre names, and performers. In addition, information about broadcast waves, channels and the like is contained. When, for example, a portion of EPG information is changed due to urgent program scheduling, the importance is considered to be high and it is necessary to transfer EPG information to other recorders. Also when a portion of program content is changed in order to respond to changes of the broadcasting date/time of a live broadcast program, program name, genre, or performer name, the importance is considered to be high and it is necessary to transfer EPG information to other recorders.

If the time interval after EPG information being first acquired until the next EPG information is acquired is made long, a portion of time information contained in EPG information may lack and thus, it is necessary to constantly acquire time information from a network. Therefore, after EPG information being acquired, each recorder immediately transmits time information of the EPG information to each recorder via the network even if the EPG information is not changed. Accordingly, even if the time interval to acquire EPG information from broadcast waves is made longer than normal, each recorder can acquire the latest program information and time information via the network.

While the data transfer rate to acquire EPG information from broadcast waves is normally up to 80 Mbps, the actual data transfer rate for EPG information acquisition is several dozen Mbps. The data transfer rate via a network, on the other hand, is up to 100 Mbps and is considered to be several times faster than the EPG information acquisition from broadcast waves. Therefore, power consumption for data transfer can be reduced by minimizing the number of times of acquiring EPG information from broadcast waves and transmitting/receiving EPG information via the network. In the foregoing, the acquisition of electronic program guide information (EPG information) and back power supply ON (ON) of recorders when four recorders are connected via a network has been described.

### [5] Operation of Transmission/Reception System

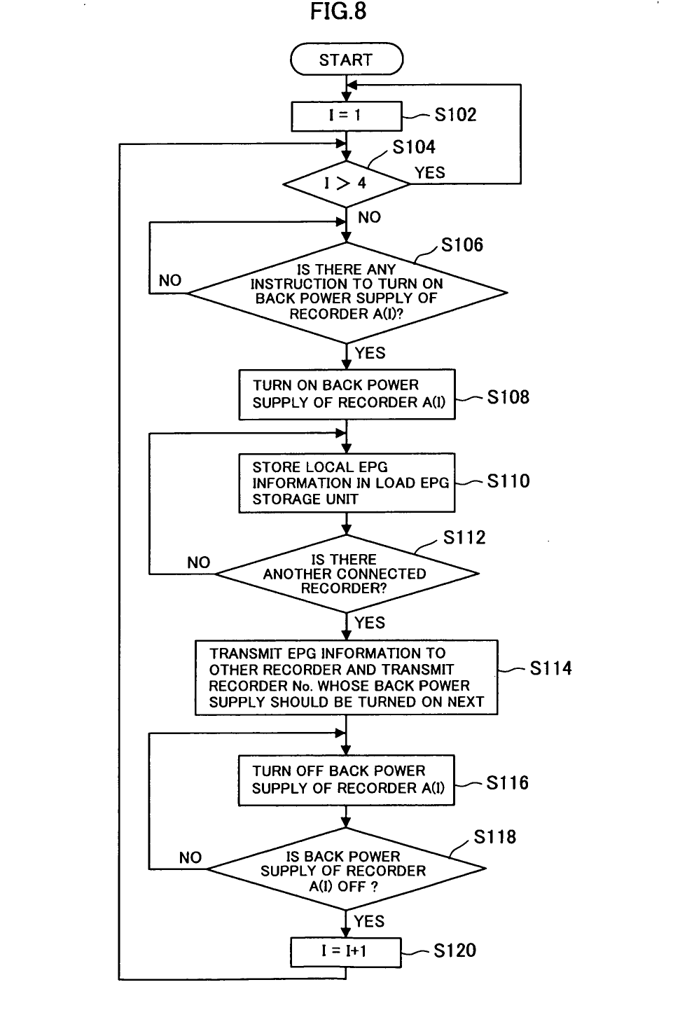

Next, the transmission method of EPG information when one recorder is connected via a network will be described with reference to FIG. 8. FIG. 8 is a flow chart illustrating the transmission method of the EPG information. As shown in FIG. 8, I=1 is set to indicate the recorder is the first one (S102). Next, whether I is larger than 4 is determined (S104). When I is smaller than 4, whether there is any instruction to turn on the back power supply of the recorder A(I) (S106) is determined. When I is larger than 4, I=1 is reset (S102).

When it is determined at step S106 that there is an instruction to turn on the back power supply of the recorder A(I), the back power supply of the recorder A(I) is turned on (S108). Then, local EPG information acquired from broadcast waves is stored in the EPG information storage unit (the storage medium 108) (S110). Next, whether there is any connected recorder is determined (S112). When it is determined at step S112 that there is another connected recorder, the EPG information is transmitted to other recorders and a recorder number whose back power supply should be turned on next is transmitted (S114).

Then, the back power supply of the recorder A(I) is turned off (S116). Then, whether the back power supply of the recorder A(I) has been turned off is determined (S118). When it is determined at step S118 that the back power supply is turned off, 1 is added to I (I=I+1) (S120). Then, processing of steps S106 to S118 is repeated. In the foregoing, the transmission method of EPG information when one recorder is connected via a network has been described. Next, transmission of a difference of EPG information will be described.

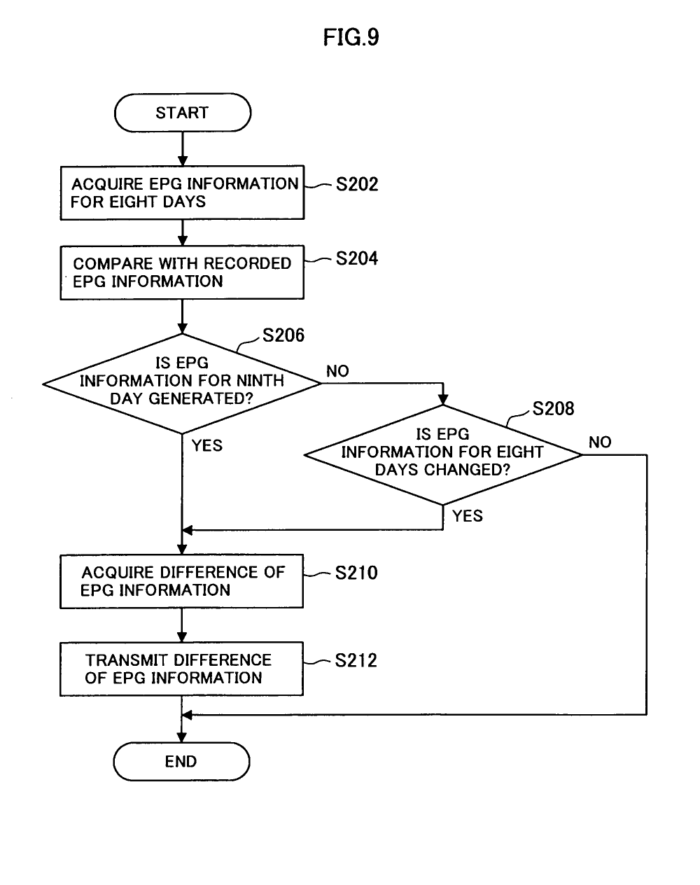

FIG. 9 is a flow chart illustrating the transmission of difference of the EPG information in the recorder. As shown in FIG. 9, a recorder whose back power supply is turned on first acquires EPG information for eight days from broadcast waves (S202). Then, EPG information already recorded in the storage medium and EPG information acquired at step S202 are compared (S204). Based on a result of comparison at step S204, whether EPG information for the ninth day has been generated is determined (S206).

When it is determined at step S206 that no EPG information for the ninth day has been generated, whether the EPG information for the eight days has been changed is determined (S208). When it is determined at step S208 that the EPG information for the eight days has been changed, processing at step S210 and below will be performed. When, on the other hand, it is determined at step S208 that the EPG information for the eight days has not been changed, processing is terminated.

When it is determined at step S206 that EPG information for the ninth day has been generated, a difference of EPG information is acquired (S210). Then, the difference of EPG information acquired at step S210 is transmitted to other recorders (S212). As described above, even if there is no difference of EPG information, time information is transmitted to other recorders. In the foregoing, the transmission of a difference of EPG information has been described.

According to the transmission/reception system 1 according to the present embodiment, electronic program guide information acquired from broadcast waves and the electronic program guide information recorded in the storage medium is compared and when the electronic program guide information has changed, the newly acquired electronic program guide information is transmitted to other apparatuses connected via a network. Moreover, the acquisition time of electronic program guide information which is when electronic program guide information should be acquired is transmitted together with the electronic program guide information so that electronic program guide information contained in broadcast waves is acquired at the time indicated by the transmitted acquisition time of electronic program guide information.

Accordingly, electronic program guide information can be shared by a plurality of apparatuses by reducing standby electricity. When a plurality of recorders is connected via a network, one of the plurality of recorders acquires EPG information from broadcast waves and transmits the EPG information to the other recorders. Accordingly, power consumption can be reduced by reducing the number of times of turning on power to acquire EPG information from broadcast waves.

EPG information can display program information for a total of eight days in one week from the acquisition day on a TV screen and allows to make viewing settings/recording settings and to perform a search by genre, so that multi-scheduling or changes of broadcasting time can be handled almost in real time. As described above, not only when EPG information for the ninth day after eight days is generated, but also when EPG information for the eight days changes, that is, abrupt changes, can also be handled. Accordingly, for example, a case in which broadcasting times of subsequent programs are changed due to an extended sports broadcast can also be handled.

In the present embodiment, EPG information is acquired from broadcast waves by periodically turning on only one recorder among a plurality of recorders, and EPG information is transmitted to the other recorders only when the EPG information changes. Accordingly, the number of times of turning on one recorder can be reduced and, furthermore, data can be transmitted via a network to reduce power consumption and also electronic program guide information can be shared by a plurality of apparatuses.

It should be understood by those skilled in the art that various modifications, combinations, sub-combinations and alterations may occur depending on design requirements and other factors insofar as they are within the scope of the appended claims or the equivalents thereof.

In the above embodiment, for example, a configuration in which a plurality of recorders is sequentially turned on is adopted, but the configuration is not limited to the above example. For example, only one recorder may constantly be maintained ON so that the recorder is started to acquire EPG information. Alternatively, all recorders may acquire EPG information from a server that acquires the EPG information via a network. Also in this case, the same effect as that of the above embodiment can be achieved.

What is claimed is:

1. A transmitting apparatus, comprising:
an acquisition unit that acquires electronic program guide information contained in broadcast waves;
a recording unit that records the electronic program guide information acquired by the acquisition unit in a storage medium;
a determination unit that determines whether the electronic program guide information has changed, by comparing the electronic program guide information recorded in the storage medium and the electronic program guide information newly acquired by the acquisition unit; and
a transmitting unit that transmits, when the determination unit determines that the electronic program guide information has changed, the newly acquired electronic program guide information to one or more than one receiving apparatuses connected via a network.

2. The transmitting apparatus according to claim 1, wherein the acquisition unit acquires the electronic program guide information in a predetermined period of time,
the recording unit records the electronic program guide information in the predetermined period of time acquired by the acquisition unit in the storage medium,
the determination unit determines whether the electronic program guide information in the predetermined period of time has changed, by comparing the electronic program guide information recorded in the storage medium in the predetermined period of time and the electronic program guide information newly acquired by the acquisition unit, and
the transmitting unit transmits, when the determination unit determines that the electronic program guide information in the predetermined period of time has changed, the newly acquired electronic program guide information to one or more than one receiving apparatuses immediately after the electronic program guide information is acquired by the acquisition unit.

3. The transmitting apparatus according to claim 1, wherein the electronic program guide information contains program information indicating names and contents of programs and time information indicating a time when the electronic program guide information was acquired, and
when the determination unit determines that the electronic program guide information has not changed, the transmitting unit transmits only the time information contained in the electronic program guide information.

4. The transmitting apparatus according to claim 1, comprising a decision unit that decides an acquisition time of electronic program guide information which is when electronic program guide information is acquired subsequently, in accordance with the time when the electronic program guide information contained in the electronic program guide information was acquired, wherein
the transmitting unit transmits the acquisition time of electronic program guide information indicating when the electronic program guide information is acquired, to the receiving apparatus, together with the electronic program guide information, the acquisition time being decided by the decision unit.

5. A receiving apparatus, comprising:
a receiving unit that receives an acquisition time of electronic program guide information indicating the time when the electronic program guide information is acquired and electronic program guide information, transmitted from a transmitting apparatus connected to a network;
a recording unit that records the electronic program guide information received by the receiving unit in a storage medium;
an acquisition unit that acquires the electronic program guide information contained in broadcast waves at the time indicated by the acquisition time of electronic program guide information received by the receiving unit; and
a determination unit that determines whether the electronic program guide information has changed, by comparing the electronic program guide information recorded in the storage medium and the electronic program guide information acquired by the acquisition unit, wherein
when the determination unit determines that the electronic program guide information has changed, the recording unit records the acquired electronic program guide information in the storage medium.

6. The receiving apparatus according to claim 5, wherein the electronic program guide information contains program information indicating names and contents of programs and time information indicating a time when the electronic program guide information was acquired, and
when only the time information contained in the electronic program guide information is transmitted by the transmitting apparatus, the receiving unit updates only the time information of the electronic program guide information recorded in the storage medium.

7. A transmission method, comprising the steps of:
acquiring electronic program guide information contained in broadcast waves;
recording the acquired electronic program guide information in a storage medium;
determining whether the electronic program guide information has changed, by comparing the electronic program guide information recorded in the storage medium and the electronic program guide information newly acquired by the step of acquiring; and
transmitting, when it is determined that the electronic program guide information has changed, the newly acquired electronic program guide information to one or more than one receiving-apparatuses connected via a network.

8. A reception method, comprising the steps of:
receiving an acquisition time of electronic program guide information indicating the time when the electronic program guide information is acquired and electronic program guide information, transmitted from a transmitting apparatus connected to a network;
recording the received electronic program guide information in a storage medium;
acquiring the electronic program guide information contained in broadcast waves at the time indicated by the received acquisition time of electronic program guide information; and
determining whether the electronic program guide information has changed, by comparing the electronic program guide information recorded in the storage medium and the electronic program guide information acquired by the step of acquiring.

9. A program recording medium storing a program to cause a computer to function as a transmitting apparatus, comprising:
an acquisition unit that acquires electronic program guide information contained in broadcast waves;
a recording unit that records the electronic program guide information acquired by the acquisition unit in a storage medium;
a determination unit that determines whether the electronic program guide information has changed, by comparing the electronic program guide information recorded in the storage medium and the electronic program guide information newly acquired by the acquisition unit; and
a transmitting unit that transmits, when the determination unit determines that the electronic program guide information has changed, the newly acquired electronic program guide information to one or more than one receiving apparatuses connected via a network.

10. A program recording medium storing a program to cause a computer to function as receiving apparatus, comprising:
a receiving unit that receives an acquisition time of electronic program guide information indicating the time when the electronic program guide information is acquired and electronic program guide information transmitted from a transmitting apparatus connected to a network;
a recording unit that records the electronic program guide information received by the receiving unit in a storage medium;
an acquisition unit that acquires the electronic program guide information contained in broadcast waves at the time indicated by the acquisition time of electronic program guide information received by the receiving unit; and
a determination unit that determines whether the electronic program guide information has changed, by comparing the electronic program guide information recorded in the storage medium and the electronic program guide information acquired by the acquisition unit, wherein
when the determination unit determines that the electronic program guide information has changed, the recording unit records the acquired electronic program guide information in the recording medium.

11. A transmission/reception system, comprising:
a transmitting apparatus comprises;
an acquisition unit that acquires electronic program guide information contained in broadcast waves,
a recording unit that records the electronic program guide information acquired by the acquisition unit in a storage medium,
a determination unit that determines whether the electronic program guide information has changed, by comparing the electronic program guide information recorded in the storage medium and the electronic program guide information newly acquired by the acquisition unit, and
a transmitting unit that transmits, when the determination unit determines that the electronic program guide information has changed, the newly acquired electronic program guide information to the receiving apparatuses connected via a network, and
a receiving apparatus including;
a receiving unit that receives an acquisition time of electronic program guide information indicating the time when the electronic program guide information is acquired and electronic program guide information, transmitted from a transmitting apparatus,
a recording unit that records the electronic program guide information received by the receiving unit in a storage medium,
an acquisition unit that acquires the electronic program guide information contained in broadcast waves at the time indicated by the acquisition time of electronic program guide information received by the receiving unit, and
a determination unit that determines whether the electronic program guide information has changed, by comparing the electronic program guide information recorded in the storage medium and the electronic program guide information acquired by the acquisition unit, wherein
the transmitting apparatus and the receiving apparatus are connected via a network.
